(19) United States
(12) Patent Application Publication
(10) Pub. No.: US 2013/0159057 A1
(43) Pub. Date: Jun. 20, 2013

(54) AUTOMATIC METHOD FOR DETERMINING CONSUMER PREFERENCE LEVEL AND COMPUTER DEVICE FOR PERFORMING THE SAME

(71) Applicant: International Business Machines Corporation, Armonk, NY (US)

(72) Inventor: Mark Hsiao, Taipei (TW)

(73) Assignee: International Business Machines Corporation, Armonk, NY (US)

(21) Appl. No.: 13/707,660

(22) Filed: Dec. 7, 2012

(30) Foreign Application Priority Data
Dec. 15, 2011 (TW) 100146482

(51) Int. Cl. G06Q 30/02

(52) U.S. Cl. CPC G06Q 30/0203
USPC 705/7.32

(57) ABSTRACT

A method and computer device for determining consumer preference level automatically. The method can rapidly access a database which contains items with a plurality of attributes, which allows a user to compare and select items. The items selected by the user are marked as the “item of high preference” and the remaining unselected items as the “items of low preference” in response to the user's selection. The method then selects one or more attributes of the first comparing pair and determines a relative preference value for the given item according to the predetermined values for one or more attributes of the given item and the values for one or more attributes of the first comparing pair.

### CROSS-REFERENCE TO RELATED APPLICATION

This application claims priority from Taiwanese Patent Application No. 100146482, filed on Dec. 15, 2011, the entire contents of which are incorporated herein by reference.

### BACKGROUND OF THE INVENTION

1. Field of the Invention

The present invention relates to a method for determining consumer preference level automatically, and more particularly, to a computer device for performing the same.

2. Description of the Prior Art

A conventional method for determining consumer preference is based on a questionnaire where consumers (i.e., questionnaire respondents) answer questions presented in the questionnaire or rank specific items enumerated in the questionnaire. If consumer preference involves plenty of factors, questionnaire design will become difficult, and the number of questions or ranking items presented in the questionnaire will increase greatly. As a result, questionnaire respondents have to take overly long time to answer a lengthy questionnaire. The conventional method is neither popular nor realistic.

In view of this, U.S. published patent applications 2002/0087388, 2008/0205692, 2009/0254541, and U.S. Pat. Nos. 7,596,505 and 8,015,142 provide conventional methods for automatically determining or predicting consumer preference.

### SUMMARY OF THE INVENTION

One aspect of the present invention is: a computer system which provides multiple items for a consumer (i.e. a user) to choose from and instructs the user to choose his or her favorite item from “given options,” thereby automatically determining or predicting the level of the users' preference for the items.

Accordingly, the present invention provides a method for determining consumer preference level automatically. The method includes the following steps: (a) accessing a database of items, where the database includes N items, and each item has a plurality of attributes and a predetermined value for each attribute; (b) providing a user interface to present at least two items among N items for a user to compare at least two items and select one of at least two items; (c) marking the item selected by the user as an “item of high preference” and the remaining unselected items as the “items of low preference” in response to the user's selection, selecting one of the items of low preference automatically, and defining the selected item of low preference and the item of high preference collectively as a first comparing pair; (d) selecting one or more attributes of the first comparing pair; and (e) for a given item which has predetermined values for one or more attributes selected in step (d), determining a relative preference value for the given item according to the predetermined values for one or more attributes of the given item and the values for one or more attributes of the first comparing pair, and providing the relative preference value to an application for generating a processing result for use by the user.

Another aspect of the present invention provides a computer device including a memory and a processor. The memory includes stored computer executable commands. The processor accesses the memory to execute the computer executable command for performing the aforesaid method.

Reference throughout this specification to features, advantages, or similar language does not imply that all of the features and advantages that can be realized with the present invention should be or are in any single aspect of the present invention. Rather, language referring to the features and advantages is understood to mean that a specific feature, advantage, or characteristic described is included in at least one aspect of the present invention. Discussion of the features and advantages, and similar language, throughout this specification can, but do not necessarily, refer to the same aspect of the present invention.

The described features, advantages, and characteristics of the invention can be combined in any suitable manner in one or more aspects of the present invention. One skilled in the relevant art will recognize that the invention can be practiced without one or more of the specific features or advantages of a particular aspect. In other instances, additional features and advantages can be recognized in certain aspects that can not be present in all aspects of the present invention.

### BRIEF DESCRIPTION OF THE DRAWINGS

Features, advantages, and other aspects of various embodiments of the present invention will become more apparent from the following detailed description, when taken in conjunction with the figures illustrate several embodiments of the present invention in an exemplary rather than limiting manner.

FIG. 1 is a schematic diagram of a computer device according to a specific embodiment of the present invention.

FIG. 2 is a flow chart of a method according to a specific embodiment of the present invention.

### DETAILED DESCRIPTION OF THE PREFERRED EMBODIMENTS

As will be appreciated by one skilled in the art, the present invention can be a computer device, a method, or a computer program product.

As mentioned herein above, the present invention is: a computer system which provides multiple items for a consumer (i.e. a user) to choose from and instructs the user to choose his or her favorite item from “given options,” thereby automatically determining or predicting the level of the users' preference for the items.

In general, it is difficult for users to describe their preference in detail. For instance, users are not able to specify their diet preference in just a few words, nor is it easy for the users to define their favorite dishes. Similarly, it is difficult to require the users to rank specific dishes according to their preference. For example, a user who enjoys eating burgers can still be confronted with an intractable decision-making process that involves selecting a burger of a 3-star rating, a 4-star rating, and a 5-star rating and also giving the selected rating to cheeseburgers. With the present invention, the users need not contemplate on how to describe their preference or on what ratings to give; instead the users only need to select one of the given options (for example, by clicking on the icon of the selected option), thereby dispensing with other complicated input. Another feature of the present invention lies in great simplification of a process where the users give feedback to a computer system to increase the accuracy of the computer system in determining or predicting the users' preference.

Although the items described are exemplified mostly by dishes, persons skilled in the art understand that, the present invention is not limited to example of dishes. Instead, the items described are not necessarily tangible, but can include intangible items, such as music, movies, software, travel, or any other services, which can be offered in the form of a shopping choice to consumers.

The present invention can take the form entirely as hardware, entirely as software (including firmware, resident software, micro-code, etc.) or a combination of software and hardware that can all generally be referred to herein as a “circuit,” “module,” or “system.” The present invention can take the form of a computer program product, including any tangible medium of expression having computer-usable program code included in the medium.

Any combination of one or more computer usable or computer readable medium(s) can be utilized. The computer-usable or computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium can even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium can be any medium that can contain, store, communicate, propagate, or transport the program for use by or in connection with the instruction execution system, apparatus, or device. The computer-usable medium can include a propagated data signal with the computer-usable program code embodied, either in baseband or as part of a carrier wave. The computer usable program code can be transmitted using any appropriate medium, including but not limited to wireless, wireline, optical fiber cable, RF, etc.

Computer program code for carrying out operations of the present invention can be written in any combination of one or more programming languages, including an object oriented programming language such as Java, Smalltalk, C++, or the like and conventional procedural programming languages, such as the “C” programming language or similar programming languages. The program code can execute entirely on the user's computer, partly on the user's computer, as a stand-alone software package, partly on the user's computer, and partly on a remote computer, or entirely on the remote computer or server. In the latter scenario, the remote computer or server can be connected to the user's computer through any type of network, including a local area network (LAN) or a wide area network (WAN), or the connection can be made to an external computer (for example, through the Internet using an Internet Service Provider).

The present invention is described below with reference to flowchart illustrations and/or block diagrams of methods, apparatus (systems), and computer program products of the invention. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions can also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

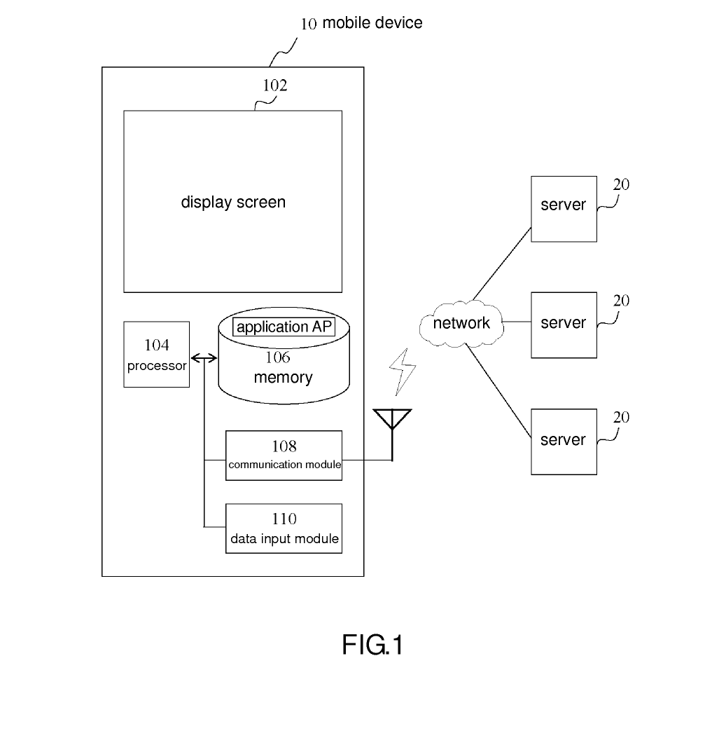

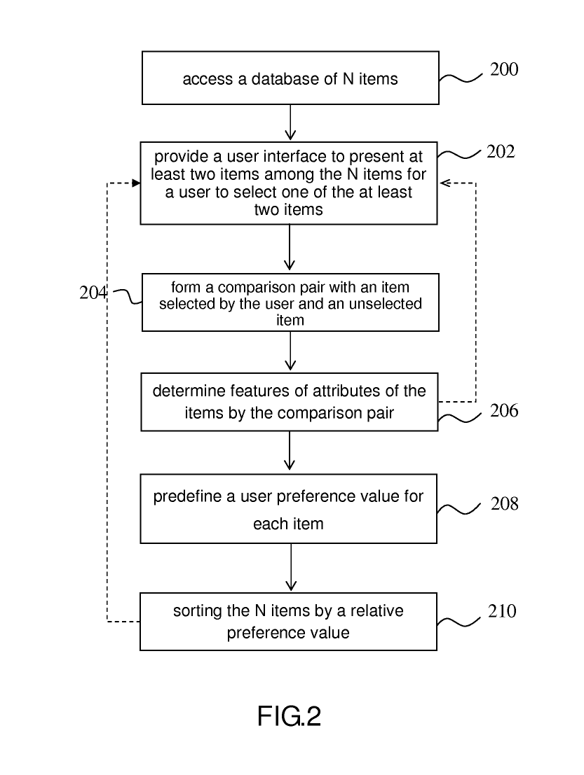

Referring now to FIG. 1 through FIG. 2, computer devices, methods, and computer program products are illustrated as structural or functional block diagrams or process flowcharts according to various aspects of the present invention. The flowchart and block diagrams illustrate the architecture, functionality, and operation of possible implementations of systems, methods, and computer program products according to various aspects of the present invention. Each block in the flowchart or block diagrams can represent a module, segment, or portion of code, which includes one or more executable instructions for implementing the specified logical function(s). In some alternative implementations, the functions noted in the block can occur out of the order noted in the figures. For example, two blocks shown in succession can, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

FIG. 1 is a block diagram of a computer device 10 in one aspect of the present invention. Mobile device 10 includes a display screen 102, a processor 104, a memory 106, a communication module 108, and a data input module 110. Computer device 10 can be implemented in the form of a conventional notebook computer or a similar portable information device. Preferably, computer device 10 is a mobile phone whose basic structure can be understood by making reference to iPhone™ of Apple™.

For example, processor 104 is a central processor manufactured by ARM™ and configured for use with the mobile device. Memory 106 is a flash memory for storing an application AP and can be accessed by the processor 104 and executed. Please refer to existing applications executed on iPhone™ for the basic implementation aspects of the application AP. Functions provided by application AP are hereunder illustrated in FIG. 2. Communication module 108 is capable of providing network connection with UMTS, GSM, or Wi-Fi and thus capable of being connected to one or more servers 20.

Data input module 110 and display screen 102 are integrated to form a touch screen where a user creates data or enters a command. In this example, memory 106 has a built-in item database DB. It is also feasible that item database DB is disposed in servers 20, where processor 104 of computer device 10 accesses item database DB in servers 20 via communication module 108.

In another example not shown, it is also feasible that computer device 10 is a mainframe or a high-level workstation with robust processing capacity and storing capacity, such as IBM's System X, Blade Center or eServer, and provides a webpage interface where the user accesses computer device 10 via a network by means of a computer device or portable device in wide use.

The required network can also come in a connection of any type, including a wide area network (WAN) or a local area network (LAN) with static IP, or a temporary connection to the Internet through an Internet service provider (ISP), whether by cable connection or by wireless connection. Persons skilled in the art are able to understand that the network can also have other hardware and software elements (such as an additional computer system, a router, or a firewall) not shown in the accompanying drawings.

FIG. 2 is a flow chart of an aspect of the present invention. FIG. 2, coupled with computer device 10 shown in FIG. 1, illustrates a method for determining consumer preference level automatically with an application AP according to an aspect of the present invention.

Step 200: create a dish database DB in memory 106 of computer device 10 or in servers 20 beforehand. To serve an illustrative purpose, dish database DB merely includes six dishes shown in Table 1 below, but the present invention is not limited thereto.

TABLE 1

| Number | Dish |
|---|---|
| D1 | Spaghetti with Seafood |
| D2 | Cheese Beef Burger |
| D3 | Wiener Schnitzel |
| D4 | Turkey Sandwich |
| D5 | Vanilla Ice Cream |
| D6 | Chocolate Cake |

Furthermore, each of the dishes D1-D6 in database DB is predefined with a plurality of dish attributes. For example, the attributes are shown in Table 2 below and can be increased or decreased as needed.

TABLE 2

| Number | Attribute |
|---|---|
| A1 | including seafood |
| A2 | including beef |
| A3 | including pork |
| A4 | including chicken |
| A5 | sugar-containing |
| A6 | chocolate-containing |
| A7 | fried |
| A8 | roasted |
| . . . | . . . |

Dishes D1-D6 enumerated in Table 1 are each predefined with an attribute value which matches a corresponding one of the aforesaid attributes. In this example, the attribute value is 1 or 0, in the situation where the dish satisfies the description of the attribute is denoted by 1; otherwise it is denoted by 0. Table 3, coupled with the attributes shown in Table 2, illustrates attribute values of the six dishes in Table 1.

TABLE 3

| | A1 | A2 | A3 | A4 | A5 | A6 | A7 | A8 |
|---|---|---|---|---|---|---|---|---|
| D1 | 1 | 0 | 0 | 0 | 0 | 0 | 0 | 0 |
| D2 | 0 | 1 | 0 | 0 | 0 | 0 | 0 | 1 |
| D3 | 0 | 0 | 1 | 0 | 0 | 0 | 1 | 0 |
| D4 | 0 | 0 | 0 | 1 | 0 | 0 | 0 | 1 |
| D5 | 0 | 0 | 0 | 0 | 1 | 0 | 0 | 0 |
| D6 | 0 | 0 | 0 | 0 | 1 | 1 | 0 | 0 |

With the attribute values enumerated in Table 3, each of the attribute values of attributes A1-A8 corresponding to dishes D1-D6, respectively, is preferably expressed in the form of an eight-dimensional vector below to perform an automatic computation process.

VD1=[1,0,0,0,0,0,0,0]

VD2=[0,1,0,0,0,0,0,1]

VD3=[0,0,1,0,0,0,1,0]

VD4=[0,0,0,1,0,0,0,1]

VD5=[0,0,0,0,1,0,0,0]

VD6=[0,0,0,0,1,1,0,0]

The dish attributes enumerated in Table 2 merely serve an exemplary purpose, as more examples of dish attributes are disclosed in U.S. published patent application 2009/0254541 and Taiwan patent application 99146949 entitled AUTOMATIC DIET PLANNING METHOD AND MOBILE DEVICE FOR PERFORMING THE SAME, where each dish attribute is related or unrelated to nutrition. In particular, the attribute values of the dish attributes are not restricted to the aforesaid binary values (i.e., either 0 or 1), but can be set to any numerical value between 0 and 1.

Step 202: computer device 10 provides a user interface (exemplified by a webpage interface or a dedicated application interface) and presents at least two dishes among dishes D1-D6 of the database DB for the user to compare at least two dishes and select one of two dishes according to the user's preference. In this step, in each instance computer device 10 can present two or more dishes for the user to choose from, and the present invention is not limited in terms of the quantity of the dishes. In practice, considerations should be given to the possibility that, in the face of an overly large number of dishes, a user finds it difficult to make a good decision.

In another aspect of the present invention, computer device 10 selects three dishes, such as dish D1 (Spaghetti with Seafood), D3 (Wiener Schnitzel), and D6 (Chocolate Cake), from dishes D1-D6 at random or in any conventional manner, and presents the three dishes to the user so that the user can compare and select one of them. For example, a computer system 10 displays icons of dish D1 (Spaghetti with Seafood), D3 (Wiener Schnitzel), and D6 (Chocolate Cake) on the webpage interface or the dedicated application interface, and the user only needs to click on one of the icons in order to finish selecting the favorite dish.

Step 204: in this example, the user chooses dish D3 (Wiener Schnitzel), and, in response to this choice, computer system 10 marks dish D3 (Wiener Schnitzel) as the high preference dish, marks dish D1 (Spaghetti with Seafood) and dish D6 (Chocolate Cake) as low preference dishes, defines high preference dish D3 and low preference dish D1 collectively as a comparing pair, and defines high preference dish D3 and low preference dish D6 collectively as another comparing pair. In step 204, computer system 10 defines high preference dish D3 and each low preference dish collectively as a comparing pair.

Step 206: determine a feature manifested by a user preference corresponding to each dish attribute. Step 206 is illustrated with Table 4 below, using a comparing pair formed with high preference dish D3 and low preference dish D1.

TABLE 4

| | A1 | A2 | A3 | A4 | A5 | A6 | A7 | A8 |
|---|---|---|---|---|---|---|---|---|
| D1 | 1 | 0 | 0 | 0 | 0 | 0 | 0 | 0 |
| D3 | 0 | 0 | 1 | 0 | 0 | 0 | 1 | 0 |

The comparing pairs shown in Table 4, since attribute value 1 of high preference dish D3 is higher than attribute value 0 of low preference dish D1, attribute A3 (including pork) and attribute A7 (fried) are marked as positive attributes, or value-upward attributes, in terms of feature. The users' preference is positively correlated with the values of attributes A3, A7; hence, the user likes a fried pork-containing dish.

Since attribute value 0 of high preference dish D3 is lower than attribute value 1 of low preference dish D1, attribute A1 (including beef) is marked as a negative attribute, value-downward attributes, in terms of feature. The user's preference is negatively correlated with the values of attribute A1; hence, the user dislikes a beef-containing dish.

Attributes A2, A4, A5, A6, and A8, the attribute value of high preference dish D3 equals the attribute value of low preference dish D1, and thus attributes A2, A4, A5, A6, and A8 are either ignored temporarily or marked as neutral attributes in terms of feature.

Attributes A1-A8, which are determined by means of comparing pairs shown in Table 4, are marked as positive attributes, a negative attribute, and neutral attributes in terms of feature and denoted by values 1, −1, and 0, respectively, and are expressed in the form of an eight-dimensional vector below to thereby perform an automatic computation process.
VC1=[−1,0,1,0,0,0,1,0]

Referring to Table 5 below, comparing pairs are formed with high preference dish D3 and low preference dish D6.

TABLE 5

| | A1 | A2 | A3 | A4 | A5 | A6 | A7 | A8 |
|---|---|---|---|---|---|---|---|---|
| D6 | 0 | 0 | 0 | 0 | 1 | 1 | 0 | 0 |
| D3 | 0 | 0 | 1 | 0 | 0 | 0 | 1 | 0 |

According to the aforesaid method, attributes A1-A8, which are determined by means of comparing pairs shown in Table 5, are marked as positive attributes, a negative attribute, and neutral attributes in terms of feature and denoted by values 1, −1, and 0, respectively, and are expressed in the form of an eight-dimensional vector below to thereby perform an automatic computation process.
VC2=[0,0,1,0,−1,−1,1,0]

Although attributes A1-A8 are marked as positive attributes, a negative attribute, and neutral attributes in terms of feature and denoted by values 1, −1, and 0, respectively, in the aforesaid method, different weights are allotted to the features of different attributes, respectively, as needed in other aspects of the present invention. For example, attributes A1-A4 are marked as a positive attribute, a negative attribute, and a neutral attribute in terms of feature and denoted by values 1, −1, and 0, respectively. Attributes A5-A6 are marked as a positive attribute, a negative attribute, and a neutral attribute in terms of feature and denoted by values 0.5, −0.5, and 0, respectively. Attributes A7-A8 are marked as a positive attribute, a negative attribute, and a neutral attribute in terms of feature and denoted by values 2, −2, and 0, respectively. The absolute values of a positive attribute and a negative attribute need not be equal, nor is it necessary to set the value of a neutral attribute to 0. Preferably, the value of a neutral attribute ranges between the value of a positive attribute and the value of a negative attribute. For example, the attributes are marked as a positive attribute, a negative attribute, and a neutral attribute in terms of feature and denoted by values 3, 1, and 2, respectively.

Step 208: relative preference values of dishes D1-D6 in database DB are determined by means of attribute values (i.e., vectors VD1-VD6) of dishes D1-D6 described in step 200 and features (i.e., vectors VC1, VC2) of attributes A1-A8 determined by the comparing pairs and described in step 206. More details are described below. However, step 208 can also be performed on any dishes other than dishes D1-D6, as long as the dishes correspond in attribute to dishes D1-D6, respectively, and can be expressed in the form of an eight-dimensional vector to thereby express their attribute values.

A way of determining relative preference values of dishes is described below. In another aspect of the present invention, the relative preference value of each dish equals the inner product of attribute values (i.e., vectors VD1-VD6) of the dish expressed in an eight-dimensional vector and features (i.e., vectors VC1, VC2) of attributes determined by comparing pairs.

For example, considerations are given only to the feature VC1 ([−1,0,1,0,0,0,1,0]) of attributes determined by comparing pairs (Table 4) of dishes D1, D3, and thus the inner product of vectors VD1-VD6 and vector VC1 equal relative preference values R1-R6 of dishes D1-D6, respectively, as shown in Table 6.

TABLE 6

| | Relative Preference |
|---|---|
| Number | Value (based on VC1) |
| R1 | −1 |
| R2 | 0 |
| R3 | 2 |
| R4 | 0 |
| R5 | 0 |
| R6 | 0 |

After calculating the relative preference values R1-R6 of dishes D1-D6, respectively, computer system 10 provides calculated relative preference values R1-R6 to an application (such as a dish recommendation program), so as to sort dishes D1-D6 by relative preference values R1-R6 (see step 210), estimate the users' preference level for dishes D1-D6 in accordance with the sorting result, and recommend a dish of high preference level (or a combo of multiple dishes) to the user. In the present invention, application AP (shown in FIG. 1) for executing step 200 through step 210 can also be integrated into the dish recommendation program or implemented in the form of an additional application, but the present invention is not limited thereto.

Unlike the conventional way of collecting user feedbacks, this aspect of the present invention requires that, throughout the process flow, only step 202 entails the user's performing a click once. Hence, persons skilled in the art gain insight into the advantages of the present invention over the prior art readily.

In another example, considerations are given only to the feature VC2 ([0,0,1,0,−1,−1,1,0]) of the attributes determined by comparing pairs (Table 5) of dishes D6, D3, and thus the inner product of vectors VD1-VD6 and vector VC2 equal relative preference values R1-R6 of dishes D1-D6, respectively, as shown in Table 7.

TABLE 7

| | Relative Preference |
|---|---|
| Number | Value (based on VC2) |
| R1 | 0 |
| R2 | 0 |
| R3 | 2 |
| R4 | 0 |
| R5 | −1 |
| R6 | −2 |

As mentioned above, after calculating the relative preference values R1-R6 of dishes D1-D6, respectively, computer system 10 sorts dishes D1-D6 by the relative preference values R1-R6 and estimates the users' preference level for dishes D1-D6 in accordance with the sorting result.

Expectedly, the result varies from comparing pair to comparing pair. A result obtained by means of a single comparing pair is likely to be biased because of insufficient samples. To introduce more samples and enhance the precision of judgment, step 206 involves adding vector VC1 and vector VC2 and then calculating the inner product of vectors VD1-VD6 and the sum ([−1,0,2,0,−1,−1,2,0]) of vector VC1 and vector VC2 to thereby figure out the relative preference values.

In another aspect of the present invention, an intersection vector ([0,0,1,0,0,0,1,0]) of vectors VC1, VC2 is calculated, and then the inner product of the intersection vector ([0,0,1,0,0,0,1,0]) and vectors VD1-VD6 is calculated to obtain the relative preference values. Step 206 requires giving considerations only to the positive attribute or negative attribute resulting from different comparing pairs consistently before going to step 208. For example, features of attributes A3, A7 are always positive attributes, regardless of whether they are determined by the comparing pairs shown in Table 4 or Table 5, thereby leading to the conclusion that the features of attributes A3, A7 are positive attributes. By contrast, taking attribute A1 as an example, features of attribute A1 are a negative attribute and a neutral attribute, respectively, i.e. inconsistent, when determined by comparing pairs shown in Table 4 and Table 5. In the inconsistent scenario, the feature of attribute A1 is preferably marked as a neutral attribute, thereby reducing its effect on the result of calculation of the relative preference values in step 208.

To introduce more samples and thereby enhance the precision of judgment, at least three methods are adopted as follows:

The first method involves presenting, in step 202, more dishes to the user such that the user can compare and select one of the dishes. Hence, in step 204, more comparing pairs are produced. In step 206, more attribute feature vectors (i.e., similar to vectors VC1, VC2) are obtained, calculating the relative preference values of the dishes is accomplished by adding up the feature vectors or figuring out their intersection. The method has the advantage of increasing the samples without increasing the frequency of user feedback. However, considerations should be given to the likelihood that a user finds it difficult to make a good decision in the face of an overly large number of dishes (options).

Unlike the first method which involves increasing the dishes presented to the user in each instance, the second method involves increasing the number of selections (clicks) performed by the user. The process flow from step 202 to step 206 can be carried out repeatedly so as to produce more comparing pairs and more attribute feature vectors, thereby calculating the relative preference values of the dishes is accomplished by adding up the feature vectors or figuring out their intersection. Preferably, in every instance of step 202, the dishes provided by computer system 10 to the user for selection include at least one dish which is not presented in the preceding instance of step 202, so as to avoid giving the same option to the user repeatedly. Furthermore, these two methods can coexist, and the second method does not require that the numbers of the dishes presented to the user in all instances of step 202 have to be equal.

The third method is a variant of the second method. In the third method, process flow from step 202 to step 206 can be carried out repeatedly so as to produce more comparing pairs and more attribute feature vectors. The third method is different from the second method in that, in the third method, before going to the next instance of step 202, the process flow entails performing step 208 once to thereby obtain dishes D1-D6 relative preference values generated in response to the users' selection in the preceding instance of step 202, so as to sort dishes D1-D6 (see step 210) and further rule out the lowest-ranked dish (such as dish D1) in accordance with the sorting result. Afterward, to perform the next instance of step 202, computer system 10 presents at least two dishes from dishes D2-D6 (where the lowest-ranked dish D1 is ruled out) such that the user can select one of at least two dishes.

Although step 206 and step 208 in the example involve determining dish attribute features (i.e., a positive attribute, a negative attribute, and a neutral attribute) by means of comparing pairs and determining the relative preference values of dishes D1-D6, respectively, the present invention is not limited thereto. Take comparing pairs in Table 4 as an example, the present invention further discloses that the values of attributes A1-A8 of dish D1 and dish D3 are expressed by points in an 8-dimensional space, respectively, as follows:
PD1=(1,0,0,0,0,0,0,0)
PD3=(0,0,1,0,0,0,1,0)

Furthermore, with the two points PD1=(1,0,0,0,0,0,0,0) and PD3=(0,0,1,0,0,0,1,0) (or more other points which denote the dishes, respectively), it is feasible that a reference line is defined within the eight-dimensional space by plotting a regression line or performing any other mathematical statistical process, to determine the relative preference values of given dishes in accordance with the projection of the values (denoted by the points within the eight-dimensional space) of attributes A1-A8 of the given dishes on the reference line.

The foregoing preferred aspect of the present invention are provided to illustrate and disclose the technical features of the present invention, and are not intended to be restrictive of the scope of the present invention. All equivalent variations or modifications made to the foregoing aspect of the present invention without departing from the spirit of the disclosure of the present invention and which should fall within the scope of the present invention as set forth in the appended claims.

What is claimed is:

1. A method for determining consumer preference level automatically comprising the following steps:
(a) accessing a database of items, wherein the database includes N items, and each item has a plurality of attributes and a predetermined value for each attribute, wherein N denotes a positive integer larger than 1,
(b) providing a user interface to present at least two items among N items for a user to compare at least two items and select one of at least two items;
(c) marking the item selected by the user as an “item of high preference” and the remaining unselected items as the “items of low preference” in response to the user's selection, selecting one of the items of low preference automatically, and defining the selected item of low preference and the item of high preference collectively as a first comparing pair;
(d) selecting one or more attributes of the first comparing pair; and
(e) for a given item which has predetermined values for the one or more attributes selected in the step (d), determining a relative preference value for the given item according to the predetermined values for the one or more attributes of the given item and the values for the one or more attributes of the first comparing pair, and providing the relative preference value to an application for generating a processing result for use by the user.

2. The method of claim 1, wherein step (d) further comprises marking one or more item attributes in the first comparing pair as positive attributes if the attribute value of the high preference item is higher than the attribute value of the low preference item, and marking one or more item attributes in the first comparing pair as negative attributes if the attribute value of the high preference item is lower than the attribute value of the low preference item.

3. The method of claim 1, wherein step (e) further comprises: for the given item which has predetermined values for the one or more items attributes selected in the step (d), determining the relative preference value for the given item according to the predetermined values for one or more item attributes of the given item and the positive attributes or the negative attributes of one or more item attributes determined in step (d).

4. The method of claim 2, wherein N is larger than 2, and step (b) involves presenting at least three items for the user to compare and select at least one of the three items, wherein step (c) further comprises selecting automatically another low preference item and defining the selected low preference item and the high preference item collectively as a second comparing pair.

5. The method of claim 2, wherein step (d) further comprises marking one or more item attributes in a second comparing pair as positive attributes if the attribute value of the high preference item is higher than the attribute value of the low preference item, and marking one or more item attributes in the second comparing pair as negative attributes if the attribute value of the high preference item is lower than the attribute value of the low preference item.

6. The method of claim 4, wherein step (e) further comprises predetermining values for the considered one or more item attributes of the first comparing pair and the second comparing pair in step (d) with regard to the given item and determining the relative preference values of the given item according to the predetermined values for one or more item attributes of the given item and a positive or negative attribute of one or more item attributes determined consistently by means of the first comparing pair and the second comparing pair in step (d).

7. The method of claim 2, further comprising repeating steps (b) through step (d) at least once before going to step (e), wherein items presented in each instance of step (b) includes at least an item not presented in a preceding instance of step (b).

8. The method of claim 2, wherein step (e) further comprises predetermining values for one or more item attributes ever considered in any instance of step (d) with regard to the given item and determining the relative preference values of the given item according to the predetermined values for one or more item attributes of the given item and a positive or negative attribute of the one or more item attributes ever determined in any instance of step (d).

9. The method of claim 7, wherein step (e) further comprises predetermining values for one or more item attributes considered in every instance of step (d) with regard to the given item and determining the relative preference values of the given item according to the predetermined values for one or more item attributes of the given item and a positive or negative attribute of the one or more item attributes ever consistently determined in any instance of step (d).

10. The method of claim 2, wherein step (e) further comprises determining a relative preference value of each of the N items of the database according to values of one or more item attributes considered in step (d) with regard to each of the N items of the database and a positive or negative attribute of one or more item attributes determined in step (d).

11. The method of claim 10, further comprising:
(f) sorting N items by the relative preference value of each said N item of the database.

12. The method of claim 10, further comprising:
(g) selecting P items automatically from the N items according to the relative preference value of each said N item of the database; and
(i) providing the user interface for presenting at least two items from the P items for the user to compare at least two items, select one of the at least two items, and execute step (c) through step (e) once again.

13. The method of claim 1, wherein N items are N dishes, and the plurality of item attributes is a plurality of dish attributes and is related or unrelated to nutrition.

14. A computer device, comprising:
a memory comprising a computer executable command; and
a processor capable of accessing the memory for executing the computer executable command to thereby perform the method of claim 1.

15. The computer device of claim 14, wherein the memory further comprises an item database.

16. The computer device of claim 14, further comprising a communication module connected to a server storing an item database, wherein the processor executes the computer executable command and is connected to the server via the communication module for accessing the item database.
